(19) United States
(12) Patent Application Publication
(10) Pub. No.: US 2026/0042613 A1
(43) Pub. Date: Feb. 12, 2026

(54) CARRIER BODY FOR CARRYING PROMOTIONAL OBJECT IN RESTAURANT AND CONVEYOR SYSTEM HAVING THE SAME

(71) Applicant: Kura Sushi, Inc., Osaka (JP)

(72) Inventor: Kunihiko TANAKA, Osaka (JP)

(21) Appl. No.: 19/365,088

(22) Filed: Oct. 21, 2025

Related U.S. Application Data
(63) Continuation of application No. PCT/JP2025/011330, filed on Mar. 24, 2025.

(30) Foreign Application Priority Data
Mar. 28, 2024 (JP) 2024-052872
Aug. 20, 2024 (JP) 2024-138990

(51) Int. Cl. B65G 17/08; A47F 10/06; G06Q 50/12

(52) U.S. Cl. CPC B65G 17/086; A47F 10/06; B65G 2207/04; G06Q 50/12

(57) ABSTRACT

A carrier body is used in a restaurant having a conveying path that has a curve and is configured to convey food and beverages. The carrier body is conveyed along the conveying path and includes: a plurality of supports placed on the conveying path; a plurality of connecting members each connected or fixed to a pair of adjacent supports of the plurality of supports to rotatably connect one of the pair of adjacent supports to the other of the pair of adjacent supports about an axis extending in a vertical direction; and an elongated promotional object configured to provide notification or performance to a customer in the restaurant, the promotional object being longer than twice or more a width of the conveying path.

### CROSS REFERENCE TO RELATED APPLICATION

This application is a continuation application of International Patent Application No. PCT/JP2025/011330 filed on Mar. 24, 2025, which designated the U.S. and claims the benefit of priority from Japanese Patent Application No. 2024-052872 filed on Mar. 28, 2024 and Japanese Patent Application No. 2024-138990 filed on Aug. 20, 2024. The entire disclosure of the above applications is incorporated herein by reference.

### TECHNICAL FIELD

The present disclosure relates to a carrier body that is conveyed by a conveyor device in a restaurant to carry a promotional object, and to a conveyor system including the carrier body.

### BACKGROUND

In restaurants (for example, conveyor-belt-type sushi restaurants), a conveyor device that conveys food and drink or the like along a conveying path may be used. Food and drink or the like placed on the conveying path is conveyed to the dining space for customers by the conveyor device. In recent years, there are various movable bodies other than food and drink to be conveyed in such a restaurant by the conveyor device. For example, by conveying an information item on which recommended menu items or the like are posted by the conveyor device, attempts are made to direct the attention of customers near the conveying path to the information item moving along the conveying path.

For example, the system described in Patent Document 1 (JP 2008-293322 A) conveys an information device including a display placed on the conveying path. For example, on the display of the information device, images and messages transmitted by customers via a communication terminal are displayed. By finding, among conveyed items being conveyed along the conveying path, the information device on which the image or message data transmitted by the customer is displayed, the customer can identify the food and drink ordered by the customer.

### SUMMARY

However, in conventional technology, when the length of a movable body conveyed by a conveyor device in a direction along a conveying path is increased, problems such as the carrier body leaving the conveying path, contacting an object outside the conveying path, and toppling of the carrier body occur particularly when passing through, e.g., a curved path. Accordingly, in conventional technology, as described in Patent Document 1, it is unavoidable to restrict the length of the carrier body conveyed by the conveyor device, and it has been difficult to sufficiently direct the attention of customers to an information item. It is conceivable to convey a plurality of carrier bodies each having a short length on the conveying path. However, even in this case, since the plurality of carrier bodies must be separated, it is difficult to say that the appearance is good, there is a lack of unity, and the impact on customers is weak. As described above, in conventional technology, it has been difficult to sufficiently and appropriately attract the attention of customers to a carrier body on the conveying path.

A typical objective of the present disclosure is to solve at least some of the above problems and to provide a carrier body and a conveyor system that can sufficiently and appropriately attract the attention of customers.

In a first aspect of the present disclosure, a carrier body is used in a restaurant having a conveying path that has a curve and is configured to convey food and beverages. The carrier body is conveyed along the conveying path and includes: a plurality of supports placed on the conveying path; a plurality of connecting members each connected or fixed to a pair of adjacent supports of the plurality of supports to rotatably connect one of the pair of adjacent supports to the other of the pair of adjacent supports about an axis extending in a vertical direction; and an elongated promotional object configured to provide notification or performance to a customer in the restaurant, the promotional object being longer than twice or more a width of the conveying path. Each of the plurality of connecting members connects the pair of adjacent supports as a set. A plurality of sets of pairs of adjacent supports are continuously connected by the plurality of connecting members in an elongated manner to form a continuous upper surface having a length along a conveying direction of the conveying path longer than twice or more the width of the conveying path. The plurality of connected supports meander and move along the curve of the conveying path to carry the promotional object while supporting the promotional object by the continuous upper surface. The promotional object is configured to be deformable in accordance with a meandering shape of the plurality of supports.

In a second aspect of the present disclosure, a carrier body is used in a restaurant having a conveying path that has a curve and is configured to convey food and beverages. The carrier body is conveyed along the conveying path and includes: a plurality of supports placed conveyed on by the conveying path; and a notification device placed on the plurality of supports and configured to provide an electrical notification to a customer in the restaurant. The plurality of supports are arranged along the conveying path. The notification device has an elongated shape along the conveying path to extend across at least two or more supports of the plurality of supports. The plurality of supports are configured to support the notification device in a state where the notification device faces the customer in the restaurant.

In a third aspect of the present disclosure, a conveyor system in a restaurant for conveying food and beverages includes: a conveyor device configured to convey an item placed on a conveying path having a curve; and a carrier body placed on the conveying path and conveyed along the conveying path. The carrier body comprises: a plurality of supports placed on the conveying path; a plurality of connecting members each connected or fixed to a pair of adjacent supports of the plurality of supports to rotatably connect one of the pair of adjacent supports to the other of the pair of adjacent supports about an axis extending in a vertical direction; and an elongated promotional object configured to provide notification or performance to a customer in the restaurant, the promotional object being longer than twice or more a width of the conveying path. Each of the plurality of connecting members connects the pair of adjacent supports as a set. A plurality of sets of pairs of adjacent supports are continuously connected by the plurality of connecting members in an elongated manner to form a continuous upper surface having a length along a conveying direction of the conveying path longer than twice or more the width of the conveying path. The plurality of connected supports meander and move along the curve of the conveying path to carry the promotional object while supporting the promotional object by the continuous upper surface. The promotional object is configured to be deformable in accordance with a meandering shape of the plurality of supports.

According to the carrier body and the conveyor system of the present disclosure, it is possible to sufficiently and appropriately attract the attention of customers.

The carrier body used in a restaurant and exemplified in the present disclosure is placed on a conveying path that has a curve and is configured to convey food and beverages, and is conveyed along the conveying path. The restaurant carrier body of the present disclosure comprises a plurality of supports and a plurality of connecting members. Each of the supports is placed on the conveying path. Each of the connecting members is connected or fixed to each of a pair of adjacent supports of the plurality of supports to rotatably connect one of the supports to the other support about an axis extending at least in a vertical direction. By configuring each of the plurality of connecting members to continuously and longitudinally connect sets of the adjacent supports, the plurality of connected supports meander and move along the curve of the conveying path.

According to the carrier body of the present disclosure, a plurality of supports connected by connecting members meander along a curve of the conveying path. Accordingly, even if the length of the carrier body in the direction along the conveying path is increased, the carrier body appropriately moves in a state in which problems such as the carrier body leaving the conveying path, contacting an object outside the conveying path, and toppling are unlikely to occur. Furthermore, the support can support an object. Therefore, the plurality of connected supports can also move along the conveying path in a state of supporting, for example, an elongated object or the like that is difficult to support with only a single support member. Thus, by using the carrier body of the present disclosure, a restaurant can sufficiently and appropriately attract the attention of customers to the carrier body on the conveying path.

### BRIEF DESCRIPTION OF DRAWING

FIG. 1 is a plan view showing a schematic configuration of a conveyor system 100 according to an embodiment.

FIG. 2 is a perspective view of a carrier body 1 of the present embodiment.

FIG. 3 is a plan view of a front-end support 10A and an intermediate support 10C connected by a connecting member 30.

FIG. 4 is a plan view showing a state in which the front-end support 10A has rotated relative to the intermediate support 10C about an axis O from the state shown in FIG. 3.

FIG. 5 is a perspective view of a detachable member 50.

FIG. 6 is a bottom view of the detachable member.

FIG. 7 is a perspective view of a carrier body 1 in a state where a promotional object 60 is installed and conveyed on a conveying path 102.

FIG. 8 is a perspective view of a carrier body 1 in a state where a promotional object 60 different from the promotional object 60 shown in FIG. 7 is placed.

### DESCRIPTION OF EMBODIMENTS

Next, a relevant technology will be described only for describing the following embodiments.

In this disclosure, the number of supports of the carrier body may be three or more. In this case, the carrier body can appropriately move along the conveying path in a state of supporting an object having a longer length in the direction along the conveying path. Therefore, it becomes easier to further attract the attention of customers to the carrier body. When the number of supports is N (N≥3), the number of connecting members may be N−1. In this case, the N supports are appropriately connected in an elongated manner. However, it is also possible to set the number of the supports to two (the number of connecting members being one). Even in this case, compared with moving one object on the conveying path, it becomes easier to attract the attention of customers.

At least a part of an upper surface of the support, which can support an object, may be formed in a planar shape. In this case, a worker (for example, a restaurant employee) can put various objects on the upper surface of the support in a stable state. Further, at least a bottom portion of the support, which can support an object, may be formed by a substantially plate-shaped member. In this case, the worker can also stabilize the posture of the carrier body on the conveying path by directly placing the bottom surface of the bottom portion on the conveying path. However, it is also possible to change the configuration of the support. For example, the bottom surface of the support may be configured by arranging a plurality of rod-shaped members. The bottom surface of the support may be configured by a mesh-shaped member. Even in these cases, the carrier body can move along the conveying path in a state of appropriately supporting an object. The shape of the upper surface of the support may also be formed into a curved shape or an uneven shape.

Of a pair of adjacent supports, the plan-view shape of a rear end portion of the support disposed on a front side in the conveying direction of the conveying path may be formed as a rear end arc portion that is arcuate in a concave shape toward the front or in a convex shape toward the rear. The plan-view shape of a front end portion of the support disposed on a rear side in the conveying direction may be formed as a front end arc portion that is arcuate with the same curvature as the arc at the rear end arc portion of the front support and along the shape of the rear end arc portion of the front support. In this case, even if one of the pair of supports rotates relative to the other of the pair of supports when the carrier body passes through a curve of the conveying path, a gap is prevented from being generated between the pair of supports. Accordingly, defects such as an object on the support falling through the gap and an object entering the gap being pinched are appropriately reduced. Note that the expression “the plan-view shape of the rear end portion of the support is concave toward the front” indicates a state in which the rear end portion of the support is recessed toward the front.

Each connecting member may connect a pair of adjacent supports in a state where a rear end arc portion of a front support and a front end arc portion of a rear support are along each other. Each connecting member may connect the pair of supports by using, as a rotation axis for one of the supports relative to the other of the pair of supports, a center position of arcs of the rear end arc portion and the front end arc portion arranged in a state along each other. In this case, one of the pair of supports rotates relative to the other in a state where a gap between the rear end arc portion and the front end arc portion is constant, or in a state where the rear end arc portion and the front end arc portion are in contact without a gap. Accordingly, the plurality of supports more smoothly meander along the conveying path in a state in which a gap is further prevented from being generated between the pair of supports.

A specific method for forming at least one of the rear end arc portion and the front end arc portion on each of the plurality of supports can be appropriately selected. For example, in each set of a pair of adjacent supports, the rear end arc portion of the front support may be formed in a concave shape toward the front, and the front end arc portion of the rear support may be formed in a convex shape toward the front. Alternatively, in each set of a pair of adjacent supports, the rear end arc portion of the front support may be formed in a convex shape toward the rear, and the front end arc portion of the rear support may be formed in a concave shape toward the rear.

Here, a set of a pair of supports in which the rear end arc portion of the front support is concave toward the front and the front end arc portion of the rear support is convex toward the front is defined as a first set. Conversely, a set of a pair of supports in which the rear end arc portion of the front support is convex toward the rear and the front end arc portion of the rear support is concave toward the rear is defined as a second set. The first set and the second set may be mixed among sets of a plurality of supports in one carrier body. For example, along the longitudinal direction of an elongated carrier body, the first set and the second set may be alternately arranged. In any case, the plurality of supports more smoothly meander along the conveying path in a state in which a gap between the pair of supports is further unlikely to generate.

However, it is also possible to change the shape of the support. For example, at least a part of a bottom portion of each support may be formed of a plate-shaped member. The connecting member may connect a pair of adjacent supports in a state where plate-shaped portions at the bottom portions are overlapped vertically. In this case, even if one of the pair of supports rotates relative to the other, it becomes difficult for a gap to generate between the pair of supports. Accordingly, in this case, even if the plan-view shape of the support is formed into various shapes such as a rectangular shape, the plurality of supports more smoothly meander along the conveying path in a state in which a gap between the pair of supports is unlikely to generate.

Each connecting member may extend from a position (i.e., a first position) connected or fixed to one support of a pair of adjacent supports, pass above a bottom portion of the other support, and reach a connection position (i.e., a second position) of the other support. When the carrier body passes through a curve of the conveying path, the connecting member rotates relative to the support about a rotation axis. By placing the connecting member above the bottom portion of the support, even if the connecting member rotates about the rotation axis, the rotating connecting member does not interfere with the conveying path on which the support is placed. Accordingly, for example, defects such as the rotation of the connecting member being hindered by interference with the conveying path and the occurrence of scratches on the conveying path are appropriately suppressed.

However, each connecting member may extend from a position connected or fixed to one support of a pair of adjacent supports, pass below a bottom portion of the other support, and reach a connection position of the other support. In such a case, even if an object is placed on an upper surface of the bottom portion of the support, the rotating connecting member does not interfere with the object placed on the bottom portion of the support.

Each connecting member may be formed of a material having rigidity. Among each connecting member, a width in a lateral direction intersecting the conveying direction of the conveying path of at least a pair of portions connected or fixed to the support may be greater than a thickness in a vertical direction. In this case, the connecting member can connect one of the pair of adjacent supports to the other support rotatably about an axis extending in a vertical direction while suppressing rotation in other directions. Accordingly, it becomes easier for a worker to carry or handle the elongated carrier body. For example, when a worker carries the carrier body, it is possible to suppress defects such as a part of the plurality of connected supports rotating about an axis extending in the longitudinal direction and an object placed on the support falling. In addition, the strength of the connection or fixation between the support and the connecting member is also increased.

For example, the entirety of each connecting member may be formed of a plate-shaped member having rigidity. The connecting member may be connected or fixed to the support such that a width of the plate-shaped connecting member in a lateral direction is greater than a thickness in a vertical direction. In this case, the structure of the connecting member is simplified, and carrying or handling of the carrier body also becomes easier.

Of a pair of connection portions of the connecting member connected (fixed) to each of a pair of supports, at least one of the pair of connection portions may be connected to the support by a rotation connecting member (for example, a rotation pin) that relatively rotatably connects the support to the connecting member about an axis extending in a vertical direction. In this case, the pair of supports are connected in a state in which one support is rotatable relative to the other support.

Further, of the pair of connection portions of the connecting member, the connection portion different from the connection portion of the rotation connecting member may be fixed to the support. In this case, at the fixing portion between the connecting member and the support, it becomes difficult for the support to rotate relative to the connecting member. Accordingly, a worker can more easily carry or handle the elongated carrier body. However, all the pair of connection portions of the connecting member may be connected to the support by the rotation connecting member.

At least a part of an outer peripheral edge of an upper surface or a side surface of each support (that is, an outer peripheral edge of the support when viewed from above) may be provided with a protruding portion protruding upward further from the upper surface. In this case, the possibility that an object placed on the upper surface of the support will depart from the upper surface of the support is appropriately suppressed by the protruding portion.

The protruding portion may be provided at an outer peripheral end portion of the upper surface of the support (or at a side surface of the support), or may be provided at a position slightly inward from the outer peripheral end portion.

The shape of the protruding portion may be formed in a flange shape having a certain length along the outer peripheral edge. In this case, the possibility of an object on the upper surface of the support departing is more appropriately suppressed. However, it is also possible to change the specific shape of the protruding portion. For example, a plurality of rod-shaped members or a plurality of claw-shaped members arranged along the outer peripheral edge may be used as the protruding portion.

The plurality of supports may include a front-end support, a rear-end support, and an intermediate support. The front-end support is disposed on a front end side in the conveying direction of the conveying path among the plurality of supports. The rear-end support is disposed on the most rear-end-side of the plurality of supports in the conveying direction. One or more intermediate supports are disposed between the front-end support and the rear-end support among the plurality of supports. In the intermediate support, the protruding portion may be provided in a region of the outer peripheral edge of the intermediate support excluding both end portions in the front-rear direction in the conveying direction. In this case, even if an object (for example, an elongated object) is placed across the upper surfaces of two or more plurality of supports, the protruding portion is less likely to interfere with the object. Accordingly, a worker can appropriately place the object on the upper surfaces of the plurality of supports in a more stable state. For example, the upper surfaces of the plurality of supports may also be formed into parallel planes along the conveying direction.

As described above, it is also possible to connect each connecting member from a position connected or fixed to one support, passing above a bottom portion of the other support, to a connection position of the other support. In this case, by providing the protruding portion in a region of the intermediate support excluding both end portions in the front-rear direction, the connecting member appropriately rotates about the connection position at the front and rear end portions of the upper surface of the intermediate support without interfering with the protruding portion. Furthermore, by appropriately setting the positions of the protruding portions formed at both lateral sides of the intermediate support, it is also possible to appropriately regulate a rotation range of the connecting member relative to the support.

The front-end support may be provided with the protruding portion in a region of the outer peripheral edge excluding a rear end portion in the conveying direction (for example, the entirety of the region excluding the rear end portion). In this case, the possibility that an object placed on the upper surface of the front-end support will depart forward or sideways from the upper surface of the support is appropriately suppressed by the protruding portion. Furthermore, even if an object is placed across the upper surface of the front-end support and the upper surface of an adjacent intermediate support, the protruding portion is less likely to interfere with the object.

The rear-end support may be provided with the protruding portion in a region of the outer peripheral edge excluding a front end portion in the conveying direction (for example, the entirety of the region excluding the front end portion, or left and right regions excluding the front end portion and the rear end portion).

A claw portion protruding downward may be provided on a bottom surface of at least the front-end support among the plurality of supports. The plurality of supports connected by the connecting member move successively in the moving direction of the front-end support. By the claw portion on the bottom surface of the front-end support making it easier for the front-end support to be engaged with the conveying path, the moving path of the front-end support is more likely to follow the path of the conveying path. As a result, the overall moving path of the plurality of connected supports is also more likely to follow the path of the conveying path.

The claw portion on the bottom surface of the support may be provided only on the front-end support, or may be provided on each of the plurality of supports. Further, when a frictional force between the support and the conveying path is sufficient, the claw portion on the bottom surface of the support may be omitted.

At least a part of an outer peripheral edge of an upper surface or a side surface of each support (that is, an outer peripheral edge of the support when viewed from an upper side) may be provided with a cover member extending upward further from the upper surface in a state where an object supported by the support is externally visible, the cover member preventing external contact with the object. In this case, while allowing customers to visually recognize the object supported by the support, it is possible to appropriately suppress customers from contacting the object. Furthermore, the possibility that the object supported by the support will depart from the support is also appropriately reduced by the cover member.

Various materials can be adopted as the material of the cover member. For example, a resin material or the like having appropriate rigidity, appropriate flexibility, and light transmittance may be adopted as the cover member. It is also possible to use a mesh material or the like as the cover member. A reinforcing piece for maintaining the shape of an upper end portion of the cover member may be provided at the upper end portion of the cover member. In this case, since the shape of the cover member is stabilized, the appearance is improved, and the function of preventing customers from contacting the object is also easily ensured. The cover member may be provided at an outer peripheral end portion of the upper surface of the support (or at a side surface of the support), or may be provided at a position slightly inward from the outer peripheral end portion.

In the intermediate support, the cover member may be provided in a region of the outer peripheral edge excluding both end portions in the front-rear direction in the conveying direction. In this case, the cover member of the intermediate support is less likely to interfere when placing an object (for example, an elongated object) across the upper surfaces of the multiple supports. Accordingly, the carrier body can appropriately suppress customers from contacting the object while supporting various objects, such as elongated objects, by the plurality of supports.

In a restaurant provided with a conveyor device, a dining space for customers may be provided only on one side in a lateral direction intersecting the conveying direction of the conveying path. Accordingly, the cover member may be provided only on one side in the lateral direction of the outer peripheral edge of the upper surface of the support. Even in this case, the cover member can appropriately suppress customers from contacting the object.

The front-end support may be provided with the cover member in a region of the outer peripheral edge excluding a rear end portion in the conveying direction (for example, the entirety of the region excluding the rear end portion). In this case, while allowing an object to be supported across the front-end support and the upper surface of the adjacent intermediate support, it is appropriately suppressed that customers contact the object.

The rear-end support may be provided with a cover member in a region of the outer peripheral edge excluding a front end portion in the conveying direction (for example, the entirety of the region excluding the front end portion, or left and right regions excluding the front end portion and the rear end portion).

A protruding portion provided on at least a part of the outer peripheral edge of each support may also serve as a mounting portion for mounting (or fixing) the cover member on each support. In this case, while suppressing the structure of the carrier body from becoming complicated, both the departure of the object from the support and the contact of the customer with the object can be suppressed.

A specific method for mounting the cover member on the support can be appropriately selected. For example, a groove into which the cover member is inserted may be formed in the support (for example, the protruding portion provided on the support). In this case, the worker can easily mount the cover member on the support by simply inserting the cover member into the groove from above. It is also possible to mount the cover member on the support by screws or the like.

In a state where a plurality of supports connected by the connecting member are arranged in a straight line, when the carrier body is viewed from a lateral direction intersecting the conveying direction, a part of a pair of adjacent cover members along the conveying direction may overlap each other. In this case, it becomes difficult for a customer's hand or the like to be inserted through a gap between the pair of adjacent cover members. Accordingly, it is further appropriately suppressed that customers contact the object.

The carrier body may further include a detachable member. The detachable member includes a placement portion on an upper surface side (a surface facing upward) on which an object is placed. The detachable member is detachably mounted to at least one of the plurality of supports in a state where a space is secured between the placement portion and a bottom portion of the support. In this case, a worker can place various objects (for example, an elongated object extending across the plurality of connected supports) on the placement portion of the detachable member mounted on the support. Furthermore, a space is secured between the placement portion and the bottom portion of the support. Accordingly, a worker can also improve the appearance of the carrier body by disposing, in the space between the placement portion and the bottom portion of the support, an object (for example, at least one of wiring, a power supply, and a switch) that may deteriorate the appearance. In addition, a worker can secure space on the placement portion for placing an object to be visually recognized by customers by placing, in the space between the placement portion and the bottom portion of the support, an object that does not need to be visually recognized by customers. Accordingly, the attention of customers can be more sufficiently and appropriately attracted to the carrier body on the conveying path.

A specific configuration for securing a space between the placement portion of the detachable member and the bottom portion of the support can be appropriately selected. For example, the detachable member may include a support member extending further downward from a bottom surface of the placement portion (for example, at least one of a plurality of columnar members and a flange-shaped member). In this case, by the support member of the detachable member being placed on the support (for example, the bottom portion of the support), a space is appropriately secured between the placement portion and the bottom portion of the support. When the support member is provided on an outer peripheral edge of the bottom surface of the placement portion, the support member may be formed in a region of the outer peripheral edge of the bottom surface of the placement portion excluding both end portions in the front-rear direction in the conveying direction. In this case, the space between the placement portion and the support communicates across the plurality of supports connected by the connecting member. Accordingly, a worker can also pass an elongated object (for example, wiring) through the space between the placement portion and the support.

Further, a stepped portion may be formed on at least a part of the support (for example, inside the protruding portion of the support). In this case, by the detachable member being mounted on the stepped portion of the support, a space is appropriately secured between the placement portion and the bottom portion of the support.

At least a part of an upper surface of the placement portion may be formed in a planar shape. In this case, a worker can place various objects on the upper surface of the placement portion in a stable state. The placement portion may also be formed of a substantially plate-shaped member. It is also possible to change the configuration of the placement portion. For example, the placement portion may be configured by arranging a plurality of rod-shaped members. The placement portion may be configured by a mesh-shaped member. The upper surface of the placement portion may also be formed in a curved shape or an uneven shape.

The placement portion of the detachable member may be formed with a through portion that communicates a space between the placement portion and the bottom portion of the support with a space above the placement portion. In this case, a worker can pass various members (for example, wiring in a space below the placement portion and connected to an object placed on the placement portion) through the through portion. Accordingly, the attention of customers can be more appropriately attracted to the carrier body on the conveying path.

A specific configuration of the through portion can be appropriately selected. For example, the through portion may be a through-hole penetrating the placement portion in a vertical direction. The through portion may also be a notch or the like formed in a part of the outer peripheral edge of the placement portion. It goes without saying that the number and size of the through portions formed in the placement portion can be appropriately selected.

An elongated promotional object (or may be referred to as an electrical notification device) that is deformable according to a connection shape of the plurality of supports and executes an electrical performance (or an electrical notification) may be installed across the plurality of supports connected in an elongated shape by the plurality of connecting members. In this case, the carrier body can support the elongated promotional object that is difficult to support with only one support, and can move along the conveying path while causing the promotional object to execute the electrical performance. Accordingly, the attention of customers can be more sufficiently and appropriately attracted to the carrier body on the conveying path.

Various configurations can be adopted for the promotional object. For example, at least one of an electronic paper having flexibility, a plurality of monitors connected in a bendable state at connection positions, and illuminating decorations that emit light (for example, LEDs) may be used as the promotional object. Further, a speaker that generates sound may be installed on the support together with the elongated promotional object. In this case, by adding sound to the performance by the elongated promotional object, the attention of customers can be more sufficiently attracted.

However, it is also possible to change the object installed on the plurality of connected supports. For example, an elongated printed matter or the like extending across the plurality of supports may be placed on the plurality of supports. Even in this case, by conveying the elongated object that is difficult to support with only one support, the attention of customers can be sufficiently attracted. It is also possible to place a plurality of objects having a short length in the conveying direction on the plurality of connected supports.

Another embodiment of the conveyor system of the present disclosure will be described. The conveyor system of another embodiment includes a conveyor device and a carrier body. The conveyor device conveys an object placed on a conveying path. The carrier body is placed on the conveying path and is conveyed along the path of the conveying path. The carrier body has an elongated continuous upper surface having a length in a direction along the conveying direction of the conveying path that is longer than twice a width of the conveying path. The carrier body is placed on the conveying path in a state where the elongated direction coincides with the conveying direction, and can support an elongated object that is longer than twice or more the width of the conveying path and is provided for notifying or performing to customers.

According to the conveyor system of another embodiment, unlike the case of placing an object such as an advertisement or a performance article on one plate for conveying food and drink, the attention of customers can be sufficiently attracted by conveying the elongated object to notify or perform to customers. Further, when simply arranging two plates or when connecting two plates, a gap is generated between the two plates. In contrast, the carrier body of another embodiment has an elongated continuous upper surface longer than twice the width of the conveying path. Accordingly, according to the conveyor system of another embodiment, it is also possible to move along the conveying path in a state of supporting the elongated object that is difficult to support with only two plates. Therefore, the attention of customers can be sufficiently and appropriately attracted to the carrier body.

The conveyor device of the conveyor system of another embodiment may include a configuration that conveys an object along a linear conveying path (for example, directly conveying food and drink to a customer who placed an order). The carrier body of another embodiment may move along the linear conveying path.

An object supported by the carrier body of another embodiment may be an object different from food and drink or a food and drink container, and may be, for example, an object that notifies or performs to customers (guest seats). Examples of objects that notify or perform to customers include objects that perform at least one of notification of contents of food and drink, advertisement (so-called POP advertisement or the like), and notification of a message to customers (for example, appreciation, celebration, or appeal to customers). An object that notifies or performs to customers may also be an object that performs at least one of a performance by illumination and a performance by a monitor. It goes without saying that notification or performance by sound may also be adopted.

At least a part of an outer peripheral edge of an upper surface or a side surface of the support of another embodiment may be provided with a protruding portion projecting upward further from the upper surface. In this case, the possibility that an object placed on the upper surface of the support departs from the upper surface of the support is appropriately suppressed by the protruding portion. The configuration of the protruding portion of another embodiment may adopt at least a part of the configuration of the protruding portion described above.

At least a part of an outer peripheral edge of an upper surface or a side surface of the support of another embodiment may be provided with a cover member that extends upward further from the upper surface in a state where an object supported by the support is externally visible, the cover member preventing external contact with the object. In this case, while allowing customers to visually recognize the object supported by the support, it is possible to appropriately suppress customers from contacting the object. Furthermore, the possibility that the object supported by the support departs from the support is also appropriately reduced by the cover member. The configuration of the cover member of another embodiment may adopt at least a part of the configuration of the cover member described above.

The protruding portion provided on at least a part of an outer peripheral edge of the support may also serve as a mounting portion on which a cover member is mounted. In this case, while suppressing the structure of the carrier body from becoming complicated, both the departure of the object from the support and the contact of customers with the object are suppressed.

The support of another embodiment may include a placement portion on which an object is placed. The placement portion may be provided on the support in a state where a space is secured between the placement portion and a bottom portion of the support. In this case, a worker can place various objects (for example, an elongated object) on the placement portion provided on the support. Furthermore, a space is secured between the placement portion and the bottom portion of the support. Accordingly, a worker can also improve the appearance of the carrier body by placing, in the space between the placement portion and the bottom portion of the support, an object (for example, at least one of wiring, a power supply, and a switch) that becomes a factor in deteriorating the appearance. In addition, a worker can secure space on the placement portion for placing an object to be visually recognized by customers by placing, in the space between the placement portion and the bottom portion of the support, an object that does not need to be visually recognized by customers. Accordingly, the attention of customers can be more sufficiently and appropriately attracted to the carrier body on the conveying path.

The configuration of the placement portion of another embodiment may adopt at least a part of the configuration of the placement portion described above. However, the placement portion of another embodiment may be detachably mounted on the support or may be fixed to the support. In either case, by securing a space between the placement portion and the bottom portion of the support, the attention of customers can be more appropriately attracted.

The carrier body of another embodiment may be provided with an elongated promotional object that executes an electrical performance. In this case, the carrier body can support the elongated promotional object that is difficult to support with only two plates, and can move along the conveying path while causing the promotional object to execute the electrical performance. Accordingly, the attention of customers can be more sufficiently and appropriately attracted to the carrier body on the conveying path. The configuration of the promotional object of another embodiment may adopt at least a part of the configuration of the promotional object described above. A speaker that generates sound may also be installed on the support together with the elongated promotional object. In this case, by adding sound to the performance by the elongated promotional object, the attention of customers can be more sufficiently attracted.

The technology of the present disclosure can also be expressed as the following first aspect and second aspect.

### (First Aspect)

A carrier body used in a restaurant placed on a conveying path that is configured to convey food and beverages, the carrier body being conveyed along the conveying path and comprising:
a support having an elongated continuous upper surface whose length along a conveying direction of the conveying path is longer than twice or more a width of the conveying path, wherein
the support is placed on the conveying path with its longitudinal direction aligned with the conveying direction of the conveying path,
the support is configured to support an elongated object that is longer than twice or more the width of the conveying path, and
the elongated object is configured to provide notification or performance to a customer in the restaurant.

### (Second Aspect)

A restaurant conveyor system for conveying food, comprising:
a conveying device configured to convey an object placed on a conveying path; and
a carrier body placed on the conveying path and conveyed along the conveying path, wherein
the restaurant carrier body has an elongated continuous upper surface whose length in a conveying direction of the conveying path is longer than twice or more the width of the conveying path,
the restaurant carrier body is placed on the conveying path with its longitudinal direction aligned with the conveying direction of the conveying path,
the restaurant carrier body includes a support configured to support an elongated object that is longer than twice or more the width of the conveying path, and
the elongated object is configured to provide notification or performance to a customer in the restaurant.

### (Outline Configuration of Conveyor System)

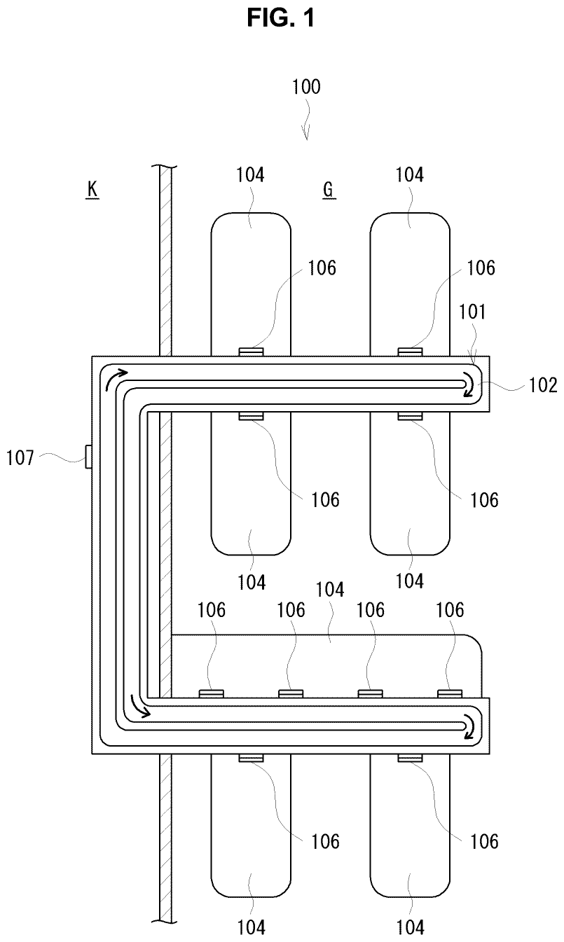

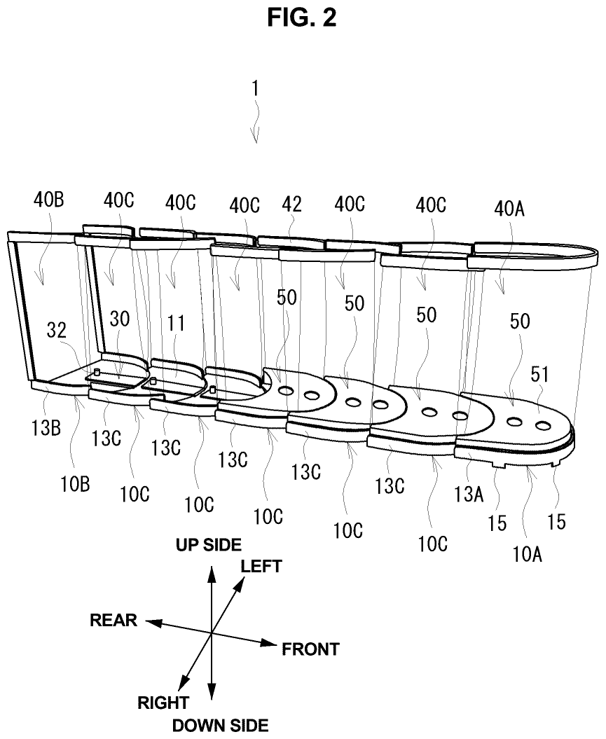

Hereinafter, one typical embodiment of the present disclosure will be described with reference to the drawings. First, referring to FIG. 1, the conveyor system 100 of the present embodiment will be described. As shown in FIG. 1, the conveyor system 100 of the present embodiment includes a conveyor device 101. The conveyor device 101 conveys objects placed on a conveying path 102 (food and drink, food and drink containers (for example, plates), and a carrier body 1 (see FIG. 2), etc.). The conveying path 102 has curves. A route (conveying route) of the conveying path 102 illustrated in FIG. 1 is a circulation route circulating between a kitchen K and a guest room G. An object placed on the conveying path 102 in the kitchen K is conveyed along the conveying route sequentially to vicinities of each of a plurality of tables 104 (dining spaces) arranged in the guest room G. An object not taken out in the guest room G returns to the kitchen K as is. As the conveying path 102, for example, a crescent chain that has a plurality of plates moving along the route can be adopted.

In the vicinity of each table 104 in the guest room G, an order device 106, which is a touch-panel display device, is provided. A customer can order a desired product by operating the order device 106. In the kitchen K, an order content display device 107, which is a touch-panel display device, is provided. A staff member checks the order contents displayed on the order content display device 107 and places the ordered product on the conveying path 102.

### (Schematic Configuration of Carrier Body)

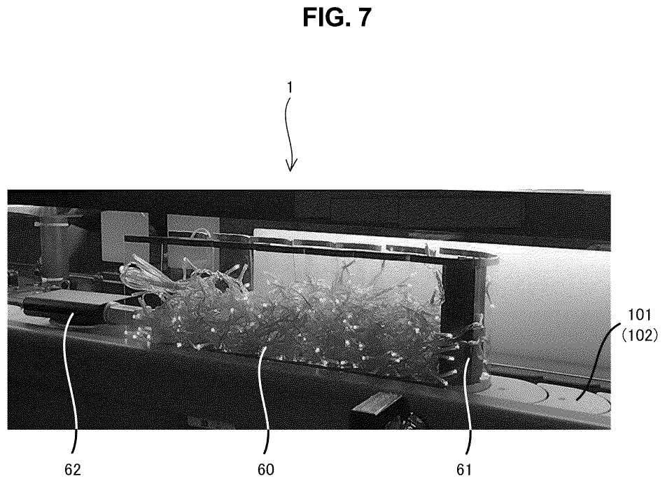

With reference to FIGS. 2 to 7, the carrier body 1 in the conveyor system 100 of the present embodiment will be described. The carrier body 1 is placed on the conveying path 102 of the conveyor device 101 (see FIGS. 1 and 7) and is conveyed along the conveying route. In FIGS. 2, 3, and 5 to 7, the right side of the drawings is defined as the front (moving direction) in the conveying direction of the conveying path 102, and the left side of the drawings is defined as the rear (direction opposite to the moving direction) in the conveying direction of the conveying path 102.

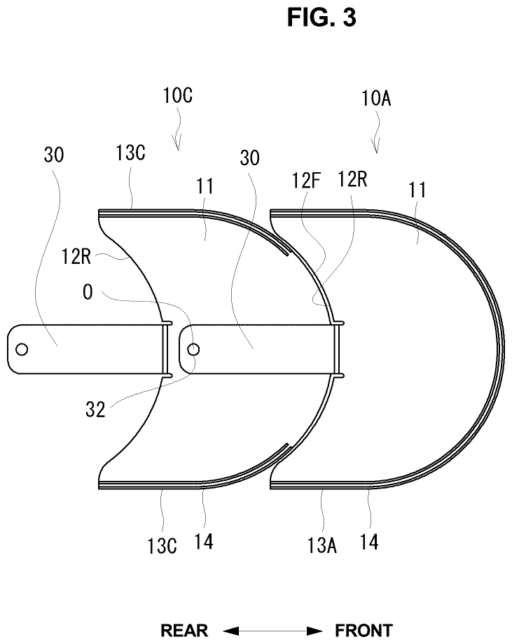

As shown in FIG. 2, the carrier body 1 of the present embodiment includes a plurality of supports 10 (10A, 10B, 10C) and a plurality of connecting members 30. The plurality of supports 10 are placed on the conveying path 102. Each of the plurality of supports 10 can support an object. Each of the plurality of connecting members 30 is connected or fixed to each of a pair of adjacent supports 10. Each of the plurality of connecting members 30 connects one support 10 to the other support 10 of the set of the connected or fixed pair of supports 10 so as to be rotatable about an axis O extending in a vertical direction (the up-down direction among the directions shown by the arrow in FIG. 2) (see FIGS. 2 and 3). That is, each of the plurality of connecting members 30 connects a pair of adjacent supports 10 as one set, and continuously connects the sets of supports 10 in an elongated shape. As a result, the plurality of supports 10 connected in an elongated shape by the plurality of connecting members 30 meander and move along the curve of the conveying path 102.

Accordingly, even if the length of the carrier body 1 in the direction along the conveying path 102 is increased, the carrier body 1 appropriately moves in a state in which problems such as the carrier body 1 leaving the conveying path 102, contacting an object outside the conveying route, and toppling are unlikely to occur. Furthermore, the supports 10 can support an object. Therefore, the plurality of connected supports 10 can also move on the conveying path 102 in a state of supporting, for example, an elongated object (for example, a promotional object (an electrical notification device) 60 described later (see FIG. 7)) that is difficult to support with only one support 10. Thus, by using the carrier body 1 of the present embodiment, a restaurant can sufficiently and appropriately attract the attention of customers to the carrier body 1 on the conveying path 102.

The carrier body 1 of the present embodiment includes three or more supports 10. Accordingly, the carrier body 1 can appropriately move on the conveying path 102 in a state of supporting an object having a longer length in the direction along the conveying path 102. In the present embodiment, when the number of supports 10 is N (N is a natural number of three or more), the N supports 10 are appropriately connected in an elongated manner by using N−1 connecting members 30.

Specifically, in the example shown in FIG. 2, viewed from the front in the conveying direction, each of the set of the first support 10A and the second support 10C, the set of the second support 10C and the third support 10C, the set of the third support 10C and the fourth support 10C, the set of the fourth support 10C and the fifth support 10C, the set of the fifth support 10C and the sixth support 10C, and the set of the sixth support 10C and the seventh support 10B is connected by the connecting member 30. In other words, viewed from the front in the conveying direction, the K-th support 10 (K is a natural number of one or more) and the (K+1)-th support 10 are rotatably connected by the connecting member 30.

In the following description, of the plurality of supports 10 to be connected, the support 10 located on a front-end side (right end side in FIG. 2) in the conveying direction of the conveying path 102 is defined as a front-end support 10A. The support 10 located on a rear-end side (left end side in FIG. 2) in the conveying direction is defined as a rear-end support 10B. One or more supports 10 disposed between the front-end support 10A and the rear-end support 10B are defined as intermediate supports 10C.

The carrier body 1 of the present embodiment further includes cover members 40 (40A, 40B, 40C). The cover member 40 is provided on at least one of the plurality of supports 10. The cover member 40 extends upward further from an upper surface of a bottom portion 11 of the support 10 in a state where an object supported by the support 10 is externally visible. The cover member 40 is provided at least on a part of an outer peripheral edge of the upper surface of the bottom portion 11 (a surface facing upward) or an outer peripheral edge of a side surface of each support 10 (that is, the outer peripheral edge of the support 10 when viewed from above). Accordingly, while allowing customers to visually recognize the object supported by the support 10, it is appropriately suppressed that customers contact the object. Furthermore, the possibility that the object supported by the support 10 departs from the support 10 is also appropriately reduced by the cover member 40. Details of the cover member 40 will be described later.

The carrier body 1 of the present embodiment further includes one or a plurality of detachable members 50. The detachable member 50 includes a placement portion 51 on an upper surface side (a surface facing upward) on which an object is placed. The detachable member 50 is detachably mounted to at least one of the plurality of supports 10 in a state where a space is secured between the placement portion 51 and the upper surface of the bottom portion 11 of the support 10. In the example shown in FIG. 2, in order to also illustrate a support 10 in a state where the detachable member 50 is not mounted, four of the seven supports 10 are shown with the detachable member 50 being mounted. However, it goes without saying that the detachable members 50 may be mounted on all of the plurality of supports 10.

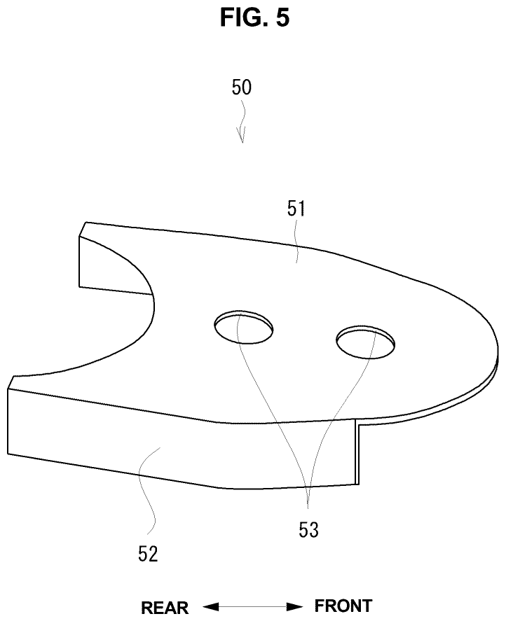

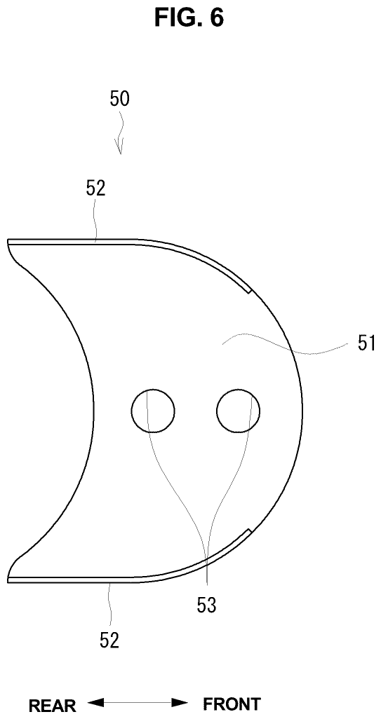

A worker can place various objects (for example, an elongated promotional object 60 described later (see FIG. 7)) on the placement portion 51 of the detachable member 50 mounted on the support 10. Furthermore, a space is secured between the placement portion 51 and the bottom portion 11 of the support 10. Accordingly, a worker can also improve the appearance of the carrier body 1 by placing, in the space between the placement portion 51 and the bottom portion 11 of the support 10, an object (for example, at least one of wiring, a power supply, and a switch) that deteriorates the appearance. In addition, a worker can secure space on the placement portion 51 for placing an object to be visually recognized by customers by placing, in the space between the placement portion 51 and the bottom portion 11 of the support 10, an object that does not need to be visually recognized by customers. Accordingly, the attention of customers can be more sufficiently and appropriately attracted to the carrier body 1 on the conveying path. Details of the detachable member 50 will be described later with reference to FIGS. 5 and 6.

### (Support and Connecting Member)

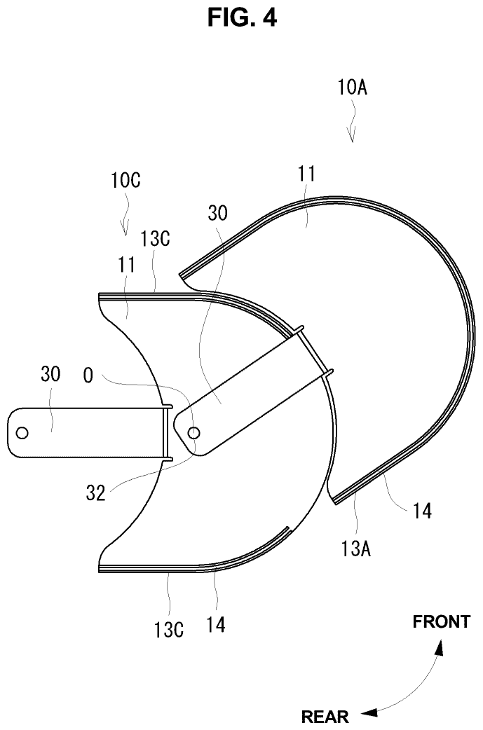

With reference to FIGS. 2 to 4, the configuration of the support 10 and the connecting member 30 in the carrier body 1 of the present embodiment will be described in detail. FIG. 3 is a plan view of the front-end support 10A and the intermediate support 10C in a state connected by the connecting member 30. FIG. 4 is a plan view showing a state in which the front-end support 10A has rotated relative to the intermediate support 10C about an axis O from the state shown in FIG. 3.

As shown in FIGS. 2 to 4, at least a part of an upper surface of the support 10 that supports an object (in the present embodiment, the upper surface of the bottom portion 11) (in the present embodiment, the entirety of the portion of the upper surface of the bottom portion 11 excluding installation positions of protruding portions 13 described later) is formed in a planar shape. Accordingly, in this case, a worker (for example, a restaurant staff) can support various objects on the upper surface of the support 10 in a stable manner. In the present embodiment, at least the bottom portion 11 of the support 10 that can support an object is formed of a plate-shaped member. Accordingly, a worker can also stabilize the posture of the carrier body 1 on the conveying path 102 by directly placing the bottom surface of the bottom portion 11 on the conveying path 102. The support 10 of the present embodiment is formed of a metal having rigidity. However, the support 10 may also be formed of another material (for example, resin).

As shown in FIGS. 3 and 4, of a pair of adjacent supports 10, at least a part of a plan-view shape of a rear end portion (a portion facing rearward) of the support 10 disposed on the front side in the conveying direction (the front-end support 10A in FIGS. 3 and 4) is formed as a rear end arc portion 12R that is arcuate in a concave shape toward the front. That is, the rear end portion of the support 10 located on the front side of the intermediate support 10C in the conveying direction is recessed toward the front. Further, of the pair of adjacent supports 10, at least a part of a plan-view shape of a front end portion (a portion facing forward) of the support disposed on the rear side in the conveying direction (the intermediate support 10C in FIGS. 3 and 4) is formed as a front end arc portion 12F that has the same curvature as the arc at the rear end arc portion 12R of the front support 10 (the front-end support 10A in FIGS. 3 and 4) and is along the rear end arc portion 12R of the front support 10. Accordingly, when the carrier body 1 passes through a curve of the conveying path 102, even if one of the pair of supports 10 rotates relative to the other, a gap can be prevented from generating between the pair of supports 10. Therefore, defects such as an object supported by the support 10 falling through the gap and an object entering the gap being pinched are appropriately reduced.

More specifically, each connecting member 30 connects a pair of adjacent supports 10 in a state where the rear end arc portion 12R of a front support 10 (the front-end support 10A in FIGS. 3 and 4) and the front end arc portion 12F of a rear support 10 (the intermediate support 10C in FIGS. 3 and 4) are aligned with each other (for example, in a state with a slight substantially constant gap or in a state of contact). Furthermore, each connecting member 30 connects the pair of supports 10 such that the center position of the arcs of the rear end arc portion 12R and the front end arc portion 12F, which are disposed in an aligned state (i.e., they fit closely), serves as the rotation axis O for the rotation of one of the pair of supports 10 relative to the other. As a result, one of the pair of supports 10 rotates relative to the other in a state where the gap between the rear end arc portion 12R and the front end arc portion 12F is substantially constant, or in a state where the rear end arc portion 12R and the front end arc portion 12F are in contact without a gap. Accordingly, the plurality of supports 10 are more easily allowed to smoothly meander along the conveying path 102 in a state where the gap between the pair of supports 10 is even less likely to generate.

As shown in FIG. 2, in the present embodiment, in all sets of adjacent pairs of supports 10, the rear end arc portion 12R of the front support 10 is formed concave toward the front, and the front end arc portion 12F of the rear support 10 is formed convex toward the front. As a result, the plurality of supports 10 connected together more smoothly meander along the conveying path. Assembly of the carrier body 1 by a worker is also facilitated. However, in all sets of adjacent pairs of supports 10, the rear end arc portion 12R of the front support 10 may be formed convex toward the rear, and the front end arc portion 12F of the rear support 10 may be formed concave toward the rear. In addition, a set of a pair of supports 10 in which the rear end arc portion 12R of the front support 10 is concave toward the front and the front end arc portion 12F of the rear support 10 is convex toward the front is defined as a first set. Conversely, a set of a pair of supports 10 in which the rear end arc portion 12R of the front support 10 is convex toward the rear and the front end arc portion 12F of the rear support 10 is concave toward the rear is defined as a second set. The plurality of sets of supports 10 in one carrier body 1 may include a mixture of the first set and the second set. For example, the first set and the second set may be alternately arranged along the longitudinal direction of the elongated carrier body 1.

As shown in FIGS. 3 and 4, each connecting member 30 extends from a position where it is connected or fixed (fixed in the present embodiment) to one of a pair of adjacent supports 10 (the front-end support 10A in FIGS. 3 and 4), passes above the bottom portion 11 of the other support 10 (the intermediate support 10C in FIGS. 3 and 4), and reaches a connection position (a rotating connection portion 32 coinciding with the axis O in the present embodiment) of the other support 10. As shown in FIGS. 3 and 4, when the carrier body 1 passes through a curve of the conveying path 102, the connecting member 30 rotates relative to the support 10 (the intermediate support 10C in FIGS. 3 and 4) around the axis O of rotation. By arranging the connecting member 30 above the bottom portion 11 of the support 10, even if the connecting member 30 rotates around the axis O of rotation, the rotating connecting member 30 will not interfere with the conveying path 102 on which the support 10 is placed. Accordingly, for example, defects such as the rotation of the connecting member 30 being hindered by interference with the conveying path 102 and the occurrence of scratches on the conveying path 102 are appropriately suppressed.

As shown in FIGS. 3 and 4, in the present embodiment, each connecting member 30 is formed of a material having rigidity. Accordingly, since the relative positional relationship between the pair of supports 10 connected by the connecting member 30 is stabilized, the plurality of supports 10 are more easily allowed to smoothly meander on the conveying path 102. The connecting member 30 of the present embodiment is formed of a metal having rigidity. However, the connecting member 30 may also be formed of another material (for example, resin).

In the present embodiment, of each connecting member 30, a width in a lateral direction intersecting the conveying direction of the conveying path of at least a pair of portions connected or fixed to the support 10 is larger than a thickness in a vertical direction. Accordingly, the connecting member 30 can connect one of a pair of adjacent supports 10 rotatably with respect to the other support 10 around the axis O extending in the vertical direction, while suppressing rotation in other directions. Therefore, a worker can more easily carry out handling such as carrying of the elongated carrier body 1. For example, when a worker carries the carrier body 1, it is possible to suppress a defect such that a part of the plurality of supports 10 connected together rotates around an axis extending in the longitudinal direction, causing an object placed on the support 10 to fall. In addition, the strength of connection or fixation between the support 10 and the connecting member 30 also increases.

In detail, in the present embodiment, the entirety of each connecting member 30 is formed of a plate-shaped member having rigidity (as one example, in the present embodiment, a metal plate). The connecting member 30 is connected or fixed to the support 10 such that a width in the lateral direction of the plate-shaped connecting member 30 is larger than a thickness in the vertical direction. Accordingly, while simplifying the configuration of the connecting member 30, it also becomes easy to carry the carrier body 1 and the like.

In the present embodiment, of a pair of connection portions of the connecting member 30 that are connected (fixed) to each of a pair of adjacent supports 10, one of the connection portions (in the present embodiment, the rear support 10 (the intermediate support 10C in FIGS. 3 and 4) of the pair of supports 10) is connected to the support 10 by a rotating connection portion 32 (for example, a rotating pin) that relatively rotatably connects the support 10 and the connecting member 30 about the axis O extending in the vertical direction. Accordingly, the other support 10 is appropriately connected in a state rotatable with respect to one support 10.

Further, in the present embodiment, of the pair of connection portions in the connecting member 30, the connection portion opposite to the connection portion by the rotating connection portion 32 (the right end portion of the right connecting member 30 in FIGS. 3 and 4) is fixed to the support 10 (in the present embodiment, the front support 10 (the front-end support 10A in FIGS. 3 and 4) of the pair of supports 10) in a non-detachable state. Accordingly, at the fixed portion between the connecting member 30 and the support 10, it becomes difficult for the support 10 to rotate relative to the connecting member 30. Therefore, a worker can more easily perform handling such as carrying of the elongated carrier body 1.

As shown in FIGS. 2 to 4, on at least a part of an upper surface (a surface facing upward) of the bottom portion 11 or an outer peripheral edge of a side surface of each support 10, protruding portions 13 (in FIG. 2, a protruding portion 13A of the front-end support 10A, a protruding portion 13B of the rear-end support 10B, and protruding portions 13C of the intermediate supports 10C) protruding further upward from the upper surface are provided. Accordingly, the possibility that an object placed on the upper surface of the bottom portion 11 of the support 10 departs from the upper surface of the bottom portion 11 is appropriately suppressed by the protruding portions 13.

The protruding portion 13 of the present embodiment is provided at least on a part of an outer peripheral edge portion of the upper surface of the bottom portion 11 of the support 10. As a result, an area of the upper surface of the bottom portion 11 on which an object can be placed is appropriately ensured. However, the protruding portion 13 may be provided at a portion inside the outer peripheral edge portion of the upper surface of the bottom portion 11. Further, in the present embodiment, the protruding portion 13 is formed in a flange shape having a constant length along the outer periphery of the bottom portion 11. As a result, for example, even when a small object is placed on the bottom portion 11 of the support 10, the possibility that the object departs is more appropriately suppressed. However, the specific shape of the protruding portion 13 can be modified. For example, a plurality of rod-shaped members or a plurality of claw-shaped members arranged along the outer periphery of the upper surface of the bottom portion 11 may be used as the protruding portion.

As shown in FIGS. 3 and 4, in the intermediate support 10C, the protruding portion 13C is provided in a region of the outer periphery of the bottom portion 11 excluding both end portions in the front-rear direction in the conveying direction (in the present embodiment, each of the left end portion and the right end portion regions). Accordingly, even when an object (for example, an elongated object) is placed across the upper surfaces of the plurality of supports 10 connected in an elongated manner, the protruding portion 13C is less likely to interfere with the object. Therefore, a worker can more appropriately and stably place an object on the upper surfaces of the plurality of supports 10. In addition, as in the present embodiment, it is also possible to form the upper surfaces of the plurality of supports 10 as parallel planes in the conveying direction.

As shown in FIG. 2, in the rear-end support 10B, protruding portions 13B are provided in regions of the outer periphery of the bottom portion 11 excluding the front end portion in the conveying direction (in the present embodiment, regions such as the left and right regions excluding the front end portion and the rear end portion). Therefore, a worker can more appropriately and stably place an object on the upper surfaces of the plurality of supports 10.

As shown in FIGS. 3 and 4, the connecting member 30 of the present embodiment extends from a connection position (a first connection position) where it is connected or fixed to one of a pair of adjacent supports 10, passes above the bottom portion 11 of the other support 10, and reaches a connection position (a second connection position) of the other support 10. In this case, by providing the protruding portions 13C in the intermediate support 10C in regions excluding both front and rear end portions in the longitudinal direction, the connecting member 30 appropriately rotates about the connection position at the front and rear end portions of the upper surface of the intermediate support 10C without interfering with the protruding portions 13C. In addition, by appropriately setting the positions of the protruding portions 13C formed in the lateral direction in the intermediate support 10C, the rotation range of the connecting member 30 with respect to the intermediate support 10C is restricted to an appropriate range. Similarly, in the front end portion of the rear-end support 10B (see FIG. 2), the connecting member 30 appropriately rotates about the connection position without interfering with the protruding portions 13B. Furthermore, by appropriately setting the positions of the protruding portions 13B formed in the lateral direction in the rear-end support 10B, the rotation range of the connecting member 30 with respect to the rear-end support 10B is restricted to an appropriate range.

As shown in FIGS. 3 and 4, in the front-end support 10A, protruding portions 13A are provided in regions of the outer periphery excluding the rear end portion in the conveying direction (in the present embodiment, the entirety of the region excluding the rear end portion). Accordingly, the possibility that an object placed on the upper surface of the front-end support 10A departs forward or sideways from the upper surface of the front-end support 10A is appropriately suppressed by the protruding portions 13A. Furthermore, even when an object is placed across the upper surface of the front-end support 10A and the upper surface of the adjacent intermediate support 10C, the protruding portions 13A are less likely to interfere with the object.

As shown in FIG. 2, at least on the bottom surface of the front-end support 10A among the plurality of supports 10, a claw portion 15 protruding downward is provided. The plurality of supports 10 connected by the connecting member 30 move in succession in the moving direction of the front-end support 10A. By the claw portion 15 on the bottom surface of the front-end support 10A, the front-end support 10A is more easily engaged with the conveying path 102, so that the moving path of the front-end support 10A tends to follow the path of the conveying path 102. As a result, the overall moving path of the plurality of supports 10 connected together also tends to follow the path of the conveying path 102. The claw portion 15 on the bottom surface of the support 10 may be provided only on the front-end support 10A, or may be provided on each of the plurality of supports 10. Further, when the frictional force between the support 10 and the conveying path 102 is sufficient, the claw portion 15 on the bottom surface of the support 10 may be omitted.

### (Cover Member)

With reference to FIG. 2, the cover member 40 of the present embodiment will be described in detail. Various materials can be used as the material of the cover member 40. In the present embodiment, a resin material having moderate rigidity, moderate flexibility, and light transmittance (a transparent resin material in the present embodiment) is adopted as the cover member 40. It is also possible to use a mesh-shaped material as the cover member.

In the cover member 40 of the present embodiment, a reinforcing piece 42 for maintaining the shape of an upper end portion of the cover member 40 is provided at the upper end portion of the cover member 40. Accordingly, since the shape of the cover member 40 is stabilized, the appearance is improved and the function of preventing customers from contacting the object is easily ensured. In addition, in the present embodiment, the cover member 40 is provided at an outer peripheral edge portion (which can also be referred to as a side surface) of the upper surface (the surface facing upward) of the bottom portion 11 of the support 10. As a result, a large area of the upper surface of the bottom portion 11 is secured. However, the cover member 40 may be provided at a portion inside the outer peripheral edge portion of the upper surface of the bottom portion 11 of the support 10.

As shown in FIG. 2, in the intermediate support 10C, a cover member 40C is provided in a region of the outer periphery excluding both front and rear end portions (the front end portion and the rear end portion) in the conveying direction. Accordingly, the cover member 40C of the intermediate support 10C is less likely to interfere when an object (for example, an elongated object) is placed across the upper surfaces of the plurality of supports 10. Therefore, the carrier body 1 can appropriately suppress customers from contacting the object while supporting various objects, such as elongated objects, by the plurality of supports 10.

As shown in FIG. 1, in a restaurant provided with the conveyor device 101, the dining space of customers may be provided only on one side in the lateral direction intersecting the conveying direction of the conveying path 102. Accordingly, the cover member 40 may be provided only on one side in the lateral direction among the outer peripheral edges of the upper surface of the support 10. Even in this case, the cover member 40 can appropriately suppress customers from contacting the object.

In the front-end support 10A of the present embodiment, a cover member 40A is provided in a region of the outer periphery of the upper surface excluding the rear end portion in the conveying direction (in the present embodiment, the entirety of the region excluding the rear end portion). Accordingly, in a state where an object is allowed to be supported across the upper surface of the front-end support 10A and the upper surface of the adjacent intermediate support 10C, customers are more appropriately suppressed from contacting the object.

In the rear-end support 10B of the present embodiment, a cover member 40B is provided in a region of the outer periphery of the upper surface excluding the front end portion in the conveying direction (in the present embodiment, regions such as the left and right regions excluding the front end portion and the rear end portion). Accordingly, in a state where an object is allowed to be supported across the upper surface of the rear-end support 10B and the upper surface of the adjacent intermediate support 10C, customers are more appropriately suppressed from contacting the object.

As shown in FIGS. 3 and 4, in the present embodiment, the protruding portions 13 (the protruding portions 13A and 13C in FIGS. 3 and 4) provided on at least a part of the outer periphery of the bottom portion 11 of each support 10 also serve as attachment portions for attaching the cover member 40. Accordingly, in a state where the configuration of the carrier body 1 is prevented from becoming complicated, both the detachment of the object from the support 10 and the contact of customers with the object are suppressed. In the protruding portion 13 of the present embodiment, a groove portion 14 into which the cover member 40 is inserted from above is formed. Accordingly, a worker can easily attach the cover member 40 to the support 10 simply by inserting the cover member 40 into the groove portion 14 from above.

As shown in FIGS. 2 and 3, in the present embodiment, when the carrier body 1 is viewed from the lateral direction intersecting the conveying direction in a state where a plurality of supports 10 connected by the connecting members 30 are arranged in a straight line, a part of a pair of adjacent cover members 40 along the conveying direction overlaps each other. As a result, it becomes difficult for a customer's hand or the like to be inserted through the gap between the pair of adjacent cover members 40.

Accordingly, the contact of customers with the object is further appropriately suppressed.

### (Detachable Member)

The detachable member 50 of the present embodiment will now be described in detail with reference to FIGS. 2, 5, and 6. FIG. 5 is a perspective view of the detachable member 50, and FIG. 6 is a bottom view of the detachable member. As described above, the detachable member 50 is detachably mounted on at least one of the plurality of supports 10 in a state where a space is secured between the placement portion 51 and the upper surface of the bottom portion 11 of the support 10. Accordingly, a worker can improve the appearance of the carrier body 1 by placing an object that deteriorates the appearance (for example, at least one of wiring, a power supply, and a switch) in the space between the placement portion 51 and the upper surface of the bottom portion 11 of the support 10.

At least a part of the upper surface of the placement portion 51 (in the present embodiment, the entirety of the upper surface of the placement portion 51) is formed in a planar shape. Accordingly, a worker can place various objects on the upper surface of the placement portion 51 in a stable state. The placement portion 51 of the present embodiment is formed by a plate-shaped member (in the present embodiment, a flat plate-shaped member). However, the placement portion may be configured by a mesh-shaped member or the like.

As shown in FIG. 2, the planar shape of the placement portion 51 of the detachable member 50 is substantially the same as the planar shape of the bottom portion 11 of the support 10, and is slightly smaller than the bottom portion 11 (specifically, the width in the lateral direction intersecting the conveying direction is slightly smaller than the width of the bottom portion 11 in the lateral direction). Accordingly, by mounting the detachable members 50 on the respective plurality of supports 10, the placement portions 51 of the plurality of detachable members 50 are positioned on the same plane. Thus, various objects (for example, elongated objects and the like) are placed on the plurality of placement portions 51 in a stable state with good appearance.

As shown in FIG. 5, the detachable member 50 of the present embodiment includes a support member 52 extending further downward from the bottom surface of the placement portion 51 (for example, at least a part of the outer peripheral edge of the bottom surface). The height of the support member 52 is set to a predetermined height (a constant height) in order to secure an appropriate space between the placement portion 51 and the bottom portion 11 of the support 10. Accordingly, when the support member 52 of the detachable member 50 is installed on the support 10 (in the present embodiment, the bottom portion 11 of the support 10), a space is appropriately secured between the placement portion 51 and the bottom portion 11 of the support 10. In the present embodiment, the support member 52 is a flange-shaped member. Therefore, the posture of the detachable member 50 mounted on the support 10 tends to be stabilized. However, the shape of the support member 52 may be changed to a columnar shape or the like.

As shown in FIGS. 5 and 6, the support member 52 is formed in a region of the outer peripheral edge of the bottom surface of the placement portion 51 excluding both end portions in the front-rear direction in the conveying direction. Accordingly, the space between the placement portion 51 and the bottom portion 11 of the support 10 communicates across a plurality of supports 10 connected by the connecting members 30. Therefore, a worker can also pass an elongated object (for example, wiring or the like) through the space between the placement portion 51 and the support 10.

The placement portion 51 of the detachable member 50 is provided with a through portion 53 that communicates from the space between the placement portion 51 and the bottom portion 11 of the support 10 to the space above the placement portion 51. Accordingly, a worker can pass various members (for example, wiring arranged in the space below the placement portion 51 and connected to an object placed on the placement portion 51) through the through portion 53. Thus, the attention of customers can be more appropriately attracted to the carrier body 1 on the conveying path 102. In the present embodiment, the through portion 53 is a through hole penetrating the placement portion 51 in the vertical direction. However, the through portion may be a notch or the like formed in a part of the outer peripheral edge of the placement portion 51.

It is also possible to change the configuration of the detachable member 50. For example, at least a part of the support 10 (for example, the inside of the protruding portion 13 of the support 10) may be formed with a stepped portion. In this case, by mounting the detachable member on the stepped portion of the support 10, a space is appropriately secured between the placement portion 51 and the bottom portion 11 of the support 10. In this case, the detachable member may be formed as a substantially flat plate-like member or the like.

### (Promotional Object)

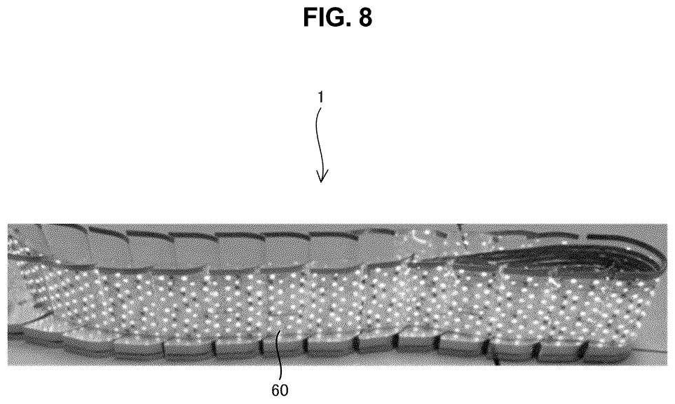

An example of a usage mode of the carrier body 1 will be described with reference to FIGS. 7 and 8. In the example shown in FIGS. 7 and 8, the carrier body 1 includes a promotional object 60. The promotional object 60 can be deformed in accordance with the curved shape of the plurality of supports 10 (see FIG. 2, etc.). The promotional object 60 can perform an electrical performance (or an electrical notification) by electric power supplied from a power supply portion 62 conveyed together with the carrier body 1. Specifically, the promotional object 60 and the power supply portion 62 are connected by wiring (not shown). The wiring may be arranged in the space between the placement portion 51 of the detachable member 50 and the bottom portion 11 of the support 10 (see FIG. 2, etc.) and may be connected to the promotional object 60 through the through portion 53 formed in the placement portion 51 (see FIGS. 5 and 6). The length of the promotional object 60 in the conveying direction by the conveying path 102 is longer than the length of one support 10 in the conveying direction. The elongated promotional object 60 is installed across the plurality of supports 10 that are elongatedly connected by the plurality of connecting members 30. Accordingly, the carrier body 1 of the present embodiment can support the elongated promotional object 60, which is difficult to support by only one support 10, and can move on the conveying path 102 while allowing the promotional object 60 to perform the electrical performance. Thus, the attention of customers can be sufficiently and appropriately attracted to the carrier body 1 on the conveying path 102.

In the example shown in FIG. 7, a plurality of illuminations (LEDs in the present embodiment) that emit light by electric power supplied from the power supply portion 62 are used as the promotional object 60. Further, in the example shown in FIG. 7, a speaker 61 that outputs sound by electric power supplied from the power supply portion 62 is installed on the support 10 together with the elongated promotional object 60. By adding sound to the performance by the elongated promotional object 60, the attention of customers can be more sufficiently attracted.

In the promotional object 60 shown in FIG. 8, a plurality of illuminations (LEDs in the example shown in FIG. 8) are regularly arranged (for example, at a constant interval) on an elongated sheet (in the example shown in FIG. 8, an acrylic sheet having light transmissivity) that can be deformed in accordance with the curved shape of the plurality of supports 10 (see FIG. 2, etc.). In the example shown in FIG. 8, the promotional object 60 is formed by attaching a plurality of LED tape lights to the elongated sheet. The LED tape light (also referred to as “LED ribbon light” or “LED strip light”) is a lighting fixture in which a plurality of LEDs are processed into a flat tape shape together with wiring. The carrier body 1 shown in FIG. 8 can provide customers with a uniform performance over an elongated wide range by being conveyed on the conveying path 102 while emitting light from the plurality of illuminations regularly arranged in the promotional object 60. Although FIG. 8 is a monochrome image and therefore difficult to understand, a plurality of illuminations provided in the promotional object 60 of FIG. 8 adopt multiple illuminations having different emission colors from each other. Among the plurality of illuminations, the plurality of illuminations belonging to the same horizontal row (or vertical row) arranged in the lateral direction emit light in the same color. Further, for each row to which the illuminations belong, any of a plurality of emission colors is selectively arranged. As a result, a unified gradation performance is developed over the elongated region. However, the emission colors of the plurality of illuminations may be the same color.

However, it is also possible to modify the configuration of the promotional object. For example, at least one of flexible electronic paper and a plurality of monitors connected in a bendable state at the connection positions may be used as the promotional object. Further, an elongated printed material extending across the plurality of supports 10 may be installed on the plurality of supports 10. Even in this case, since an elongated object that is difficult to support by only one support 10 is conveyed, it is possible to sufficiently attract the attention of customers. It is also possible to install a plurality of objects having short lengths in the conveying direction on the plurality of connected supports 10.

The technology disclosed in the above embodiment is merely an example. Accordingly, it is also possible to modify the technologies exemplified in the above embodiment. For example, it is possible to execute only a part of the technologies exemplified in the above embodiment. Specifically, in the above embodiment, the detachable member 50 is attached to the support 10, but the carrier body 1 may also be used without using the detachable member 50. Further, in a case where at least a part of the bottom portion 11 of each support 10 is formed of a plate-shaped member, the connecting member 30 may connect the pair of adjacent supports 10 in a state in which the plate-shaped portions of the bottom portions 11 are overlapped vertically. In this case, even if one of the pair of supports 10 rotates relative to the other, a gap is unlikely to occur between the pair of supports 10. Therefore, in this case, even if the planar shape of the support 10 is formed in various shapes such as a rectangular shape, the plurality of supports 10 can easily meander smoothly on the conveying path 102 in a state in which a gap between the pair of supports 10 is unlikely to occur.

1. A carrier body used in a restaurant having a conveying path that has a curve and is configured to convey food and beverages, the carrier body being conveyed along the conveying path and comprising:
a plurality of supports placed on the conveying path;
a plurality of connecting members each connected or fixed to a pair of adjacent supports of the plurality of supports to rotatably connect one of the pair of adjacent supports to the other of the pair of adjacent supports about an axis extending in a vertical direction; and
an elongated promotional object configured to provide notification or performance to a customer in the restaurant, the promotional object being longer than twice or more a width of the conveying path, wherein
each of the plurality of connecting members connects the pair of adjacent supports as a set,
a plurality of sets of pairs of adjacent supports are continuously connected by the plurality of connecting members in an elongated manner to form a continuous upper surface having a length along a conveying direction of the conveying path longer than twice or more the width of the conveying path,
the plurality of connected supports meander and move along the curve of the conveying path to carry the promotional object while supporting the promotional object by the continuous upper surface, and
the promotional object is configured to be deformable in accordance with a meandering shape of the plurality of supports.

2. The carrier body according to claim 1, wherein
the conveying path includes a crescent chain that includes a plurality of plates moving along the conveying path, and
the plurality of connecting members integrally connects the plurality of supports, and
the integrally connected plurality of supports are placed across the plurality of plates of the crescent chain on upper surfaces of the plurality of plates.

3. The carrier body according to claim 1, wherein
each of the connecting members is connected or fixed to one of the pair of adjacent supports at a first connection position and the other of the pair of adjacent supports at a second connection position, and
each of the connecting members extends between the first connection position and the second connection position passing above a bottom portion of the other of the pair of adjacent supports.

4. The carrier body according to claim 1, wherein
at least a part of an outer peripheral edge of an upper surface or a side surface of each of the plurality of supports is provided with a protruding portion that protrudes upward from the upper surface.

5. The carrier body according to claim 4, wherein
the plurality of supports include:
a front-end support arranged on a most front-end side of the plurality of supports in the conveying direction of the conveying path;
a rear-end support arranged on a most rear-end side of the plurality of supports in the conveying direction; and
one or more intermediate supports arranged between the front-end support and the rear-end support,
the one or more intermediate supports has the protruding portion in a region of the outer peripheral edge excluding both an upstream end side and a downstream end side of the one or more intermediate supports in the conveying direction, and
a cover member is not provided at the upstream and downstream end sides of the one or more intermediate supports in the conveying direction.

6. The carrier body according to claim 1, wherein
at least a part of an outer peripheral edge of an upper surface or a side surface of each of the plurality of supports is provided with a cover member that extends upward from the upper surface in a state where the promotional object supported by the plurality of supports is visible to a customer in the restaurant.

7. The carrier body according to claim 6, wherein
the plurality of supports include:
a front-end support arranged on a most front-end side of the plurality of supports in the conveying direction of the conveying path;
a rear-end support arranged on a most rear-end side of the plurality of supports in the conveying direction; and
one or more intermediate supports arranged between the front-end support and the rear-end support,
the one or more intermediate supports has the cover member in a region of the outer peripheral edge excluding both an upstream end side and a downstream end side of the one or more intermediate supports in the conveying direction, and
the cover member is not provided at the upstream and downstream end sides of the one or more intermediate in the conveying direction.

8. The carrier body according to claim 1, further comprising
a detachable member having a placement portion on which the promotional object is placed, wherein
the detachable member is detachably mounted on at least one of the plurality of supports with a space between the placement portion and a bottom portion of the at least one of the plurality of supports.

9. A carrier body used in a restaurant having a conveying path that has a curve and is configured to convey food and beverages, the carrier body conveyed along the conveying path and comprising:
a plurality of supports conveyed by the conveying path; and
a notification device placed on the plurality of supports and configured to provide an electrical notification to a customer in the restaurant, wherein
the plurality of supports are arranged along the conveying path,
the notification device has an elongated shape along the conveying path to extend across at least two or more supports of the plurality of supports, and
the plurality of supports are configured to support the notification device in a state where the notification device faces the customer in the restaurant.

10. A conveyor system in a restaurant for conveying food and beverages, comprising:
a conveyor device configured to convey an item placed on a conveying path having a curve; and
a carrier body placed on the conveying path and conveyed along the conveying path, wherein
the carrier body comprises:
a plurality of supports placed on the conveying path;
a plurality of connecting members each connected or fixed to a pair of adjacent supports of the plurality of supports to rotatably connect one of the pair of adjacent supports to the other of the pair of adjacent supports about an axis extending in a vertical direction; and
an elongated promotional object configured to provide notification or performance to a customer in the restaurant, the promotional object being longer than twice or more a width of the conveying path, wherein
each of the plurality of connecting members connects the pair of adjacent supports as a set,
a plurality of sets of pairs of adjacent supports are continuously connected by the plurality of connecting members in an elongated manner to form a continuous upper surface having a length along a conveying direction of the conveying path longer than twice or more the width of the conveying path, and
the plurality of connected supports meander and move along the curve of the conveying path to carry the promotional object while supporting the promotional object by the continuous upper surface, and
the promotional object is configured to be deformable in accordance with a meandering shape of the plurality of supports.
